(19) United States
(12) Patent Application Publication
(10) Pub. No.: US 2025/0086263 A1
(43) Pub. Date: Mar. 13, 2025

(54) Proof Of Unique Personhood For User Authentication, Bot Detection, and Quantum Safe Encryption

(71) Applicants: Thomas Robert Messegee, Clearwater, FL (US); Amy Kathryn Colleen Messegee, Clearwater, FL (US)

(72) Inventors: Thomas Robert Messegee, Clearwater, FL (US); Amy Kathryn Colleen Messegee, Clearwater, FL (US)

(21) Appl. No.: 18/466,359

(22) Filed: Sep. 13, 2023

(51) Int. Cl. G06F 21/36

(52) U.S. Cl. CPC G06F 21/36

(57) ABSTRACT

A method for proof of unique personhood for user authentication, bot detection, and quantum-safe encryption is described. The method asks users to designate a drawing of one or more points and/or lines that will serve as proof of their unique personhood and as any one or more of the following: a unique passcode, user authentication method, quantum-safe encryption seed, and bot detector. Measures of the mark itself as well as measures of the cadence (stops, starts and pauses) of how the user drew it, and the natural human variations in how the user draws the mark over subsequent visits are stored, rather than thrown out, and used to train adaptive and machine learning algorithms to recognize the unique human user as well as for creating quantum-safe encryptions keys, passwords, and for preventing bots and artificial intelligence entities from creating or accessing accounts and critical data.

### RELATED APPLICATIONS

Not applicable.

### FEDERALLY SPONSORED RESEARCH OR DEVELOPMENT

Not applicable.

### BACKGROUND/SUMMARY

### Field of the Invention

This invention relates to the fields of proof of personhood, cryptographic user authentication, information engineering, password authentication, counter quantum computing, bot detection, bot prevention, and counter artificial intelligence.

### Background of the Invention

Current methods for user authentication and encryption seed generation are based on letters, numbers, special characters and words. Over the years, the ability of human and software bot hackers to break these seeds and passwords, and to create accounts that appear authentically human, has grown increasingly sophisticated. As such, passwords and encryption seeds have become longer and more complex, and platforms maintain efforts to root out accounts created by and administrated by bots and Artificial Intelligence (AI) entities. Over time, software bots became more effective, and are now able to create thousands to millions of fake accounts on platforms worldwide. Having now simultaneously entered the era of quantum computing and widely available artificial intelligence, the field of user authentication has crossed into a time when the very human nature of the user is in question, along with the security of their data. The need to prove that the user is a human being and not a software bot or artificial intelligence has given rise to the concept of “proof of personhood”. We need to be able to identify if a given user is a human being or a bot/AI. At the same time, we have exhausted the ability of the average user to remember longer alpha-numeric and linguistic-based passwords and encryption seeds.

Biometric methods such as fingerprints, face scanning, and retinal scanning have been implemented in commercially available devices to assist with this proof of unique personhood. While these methods work well, they do not respect user privacy and may make sensitive user biometric data vulnerable to hacking, ransomware attacks and the creation of deep fake images and video.

The widespread use of “CAPTCHAs” for bot detection was adopted by many user authentication systems over the last twenty years. These methods include asking the user to identify an alphanumeric sequence in a photo, or to identify items within an image or within a set of images, and similar tasks, to prove that the user is a human being. These methods were the state of the art for bot detection and were effective, until now. In an article titled, “An Empirical Study & Evaluation of Modern CAPTCHAs,” by Andrew Searles, Yoshimichi Nakatsuka, Ercan Ozturk, Andrew Paverd, Gene Tsudik, and Ai Enkoji (submitted to arXiv.org on Jul. 22, 2023; see this link:

https://arxiv.org/abs/2307.12108), we see that modern bots are far better than humans at solving all five types of CAPTCHA bot detectors tested (see Table 3 in that report). In other words, CAPTCHAs are no longer effective bot detectors.

Graphical passwords were introduced to increase the complexity of passwords and encryption seeds while making it easy for the human user to remember them. U.S. Pat. No. 5,559,961 issued to Blonder on Sep. 24, 1996 details a graphical password method where a user is shown an image wherein they tap various regions of the image in a certain order to create a password. This method offers a limited number of “tap regions” and thus a smaller number of possible passwords. In the current era of high speed and quantum computing, these shorter passwords will not be complex enough to offer any real security. Other graphical password methods with the same problem of too few combinations can be found in U.S. Pat. No. 5,608,387 issued to Davies on Mar. 4, 1997 and U.S. Pat. No. 6,686,931 issued to Bodnar on Feb. 3, 2004. These methods are additionally vulnerable to bots and AI entities creating and accessing accounts as such a password is very repeatable and easy to guess.

In August 1999, in the Proceedings of the 8th USENIX Security Symposium, Ian Jermyn demonstrated a method allowing users to draw a sketch comprised of several lines on a 4×4 grid (see Jermyn, Ian; Alain Mayer; Fabian Monrose; Michael K. Reiter; Aviel D. Rubin (1999). The Design and Analysis of Graphical Passwords. at this link: https://www.usenix.org/legacy/events/sec99/full_papers/jermyn/jermyn_html/). The coordinates of the grid areas crossed by the lines, in order, became the user's password, and the basis for an encryption seed for a SHA-1 encryption algorithm. In those days, such a small password and seed complexity would have been sufficient, and the fact that each user was a human being was not in question. In this approach, the natural variations each time the user draws the password again are thrown out by only counting whether the lines passed through any part of the 16 available regions. If the line landed anywhere in a given region, that region's coordinates became part of the password. This method is not in use today as the possible number of combinations for passwords and seeds that derive from this method is too small to provide sufficient security from modern hacking threats. Further, bots and AI entities could use the fact that this approach is based on regions of the drawing area to make a very precisely repeatable drawing as a password for creating and accessing accounts.

U.S. Pat. No. U.S. Pat. No. 8,024,775-B2 assigned to Microsoft Corporation on Sep. 20, 2011 details a method by which edge orientation patterns are used on a user-drawn sketch to create a password. The method disclosed in that patent allows access to any user (human or bot) who can draw the sketch precisely enough, based on the specific measure of edge orientation patterns. The natural variation in human repetitions of the sketch are not considered, but are thrown out by allowing some variation to be close enough. This method can also be exploited by bots and AI entities to create and access accounts by creating a sketch and repeating it precisely on each visit.

U.S. Patent No. US20160188865-A1 issued to Tao on Jun. 30, 2016 details a different approach wherein a user is presented with a 3-dimensional grid. The user selects a series of intersection points in some order. The ordered coordinates of these intersections becomes the user's password. This creates a large set of possible combinations which helps to solve the issue of password complexity, and makes the password a little more memorable to the user, if they can remember which intersections they had tapped to create it. The problem with this approach is that the user has no special connection to a 3D grid, so remembering where they tapped to make their password will be more difficult. Bots and AI entities, however, will have no problem creating and accessing accounts using such passwords where precision memory is an advantage. Bots and AI entities can simply mimic taps on specific coordinates and repeat those coordinates precisely on each visit.

U.S. Pat. No. U.S. Pat. No. 9,740,884-B2 issued to Hawkins on Aug. 22, 2017 discloses a method wherein a user is presented with an image and then chooses regions within that image by tapping or drawing. The resulting image regions, much like the methods in Blonder's 1996 patent, are then used to create a password and an encryption seed. Unlike Blonder's patent, this method also opens up the possibility of using information on the timing and pressure of taps and strokes on the image regions as well as measures of the image itself such as color. While this increases the number of possible combinations and therefore the complexity of the resulting password, this method does not prove that the user is a human being. A bot or AI entity could easily create and replicate such a password.

What is needed now is a method for user authentication that is simple and easy for the user to remember, non-biometric for privacy, proves you are the unique human you say you are, and—without additional inputs or effort—provides highly complex passwords and quantum-safe encryption seeds.

### BRIEF SUMMARY OF THE INVENTION

This invention provides a method for proof of unique personhood for a user in a computer-based system, as a form of user authentication, bot detection, and seed creation for quantum-safe encryption. This invention seeks to extend and improve upon previous methods which create large password spaces with large complexity, to now meet the current need for determining if a user is human, and if that user is the human they claim to be. This invention improves upon those methods to address proof of unique personhood.

In this method, a user draws a drawing or mark of their own design, with the mark consisting of one or more points and/or lines. For human beings, there is a natural variation in each repetition of the same mark. That is, the same person will draw their personal mark slightly differently each time. The invention uses the natural variations in the user's repetitions of the drawing on each visit to recognize the individual human who drew it. Instead of throwing out the variations in each repetition, and seeking a graphical password drawing that is “close enough” for authentication, this invention uses these natural human variations as a non-biometric fingerprint for the user.

Bots and AI entities could be able to create a mark in the future, but will make the mark too precisely, with non-human variation, or within the statistical range of computer-based pseudo-random noise generators. The organic nature of the human body and nervous system, changing eyesight over time, changing moods, health and sleep patterns, all contribute to offer a different kind of variation in each repetition of the mark than what a bot or AI entity can be programmed to deliver. You can program a bot or AI entity to vary how they draw a given mark, but those variations will show a level of predictability or a pattern in the variation, inconsistent with that of a human being. The imprecise nature of variation in a human drawn mark can be used by machine learning (non-AI or AI based) systems to establish recognition of not just the user's chosen mark, but of equal importance, how that particular user draws it.

The method includes measuring the precise coordinates of the mark, plus a timestamp on each coordinate, and measures of the historical variations found in each repetition of the mark's coordinates and timestamps on the first and subsequent visits. The cadence of the mark is defined as the timing, intentional and natural pauses and stops as measured in the timestamps on each coordinate. The time differences between various points in the mark and other measures of cadence are included in the analysis. The user might intentionally use pauses, stops and starts within the mark to create additional security, and this will provide additional natural cadence measures each time they repeat the mark on subsequent visits. Another human being, even one who knew what the mark looked like, and the order in which to draw it, would demonstrate different variations in the placement and cadence of the mark's elements, thereby giving themselves away as an unauthorized user.

The ordered, timestamped coordinates of the mark, along with the historical variation and cadence data provide the basis for a password and for an encryption seed with a number of possible combinations too large for current and future quantum computing algorithms to break. Consider an example implementation where the user has a two dimensional drawing area of 300×300 pixels, with 10 seconds to draw a mark. Suppose that, in this example, we record 100 points and their associated timestamp data to characterize the mark. That provides more than (90,000)∧100 possibilities for the coordinate set. The ordered, timestamped coordinate set can then be used as a 300 character long secret seed for creating quantum-safe encryption keys. While this is much more than required for ensuring quantum-safe passwords and encryption seeds by today's standards, as quantum computing capabilities improve, such a level of complexity offers future quantum-security as well. Even a simple input screen like the one described in the above example is enough to provide very secure passwords and encryption seeds. This massive complexity is, however, hidden behind a simple, easy to remember and enjoyable mark uniquely created by each user. The larger the drawing area, and the longer you offer the user to draw the mark, the larger the space of possible passcodes and seeds becomes, and the greater the security offered by the method.

### BRIEF DESCRIPTION OF THE FIGURES

The accompanying figures are referenced in the detailed description. Each item in each figure has a three digit number. The first digit indicates the first figure in which that item appears. When the same item appears in a subsequent figure, it is shown with the original reference number.

FIG. 1 shows example user marks in example styles of input areas.

FIG. 2 is a flow chart showing a process for using the method for user authentication and proof of personhood in an example system.

FIG. 3 is a flow chart showing a process for key production and user characterization in an example system.

### DETAILED DESCRIPTION OF THE INVENTION

A computer-implemented method for proof of unique personhood is described. The method allows users to designate a drawing or mark of one or more points and/or lines that will serve as proof of their unique personhood and simultaneously serve as: a unique passcode, user authentication method, quantum-safe encryption seed, and bot detector.

Via a user interface (201), a user is asked to draw a symbol or mark (101, 102, 103, 104) which will be associated with their user account and used for proof of personhood. This symbol might be created by the user, or might be selected from a set of one or more randomly generated or pre-determined symbols or marks. In the example implementation, the user creates their own mark design.

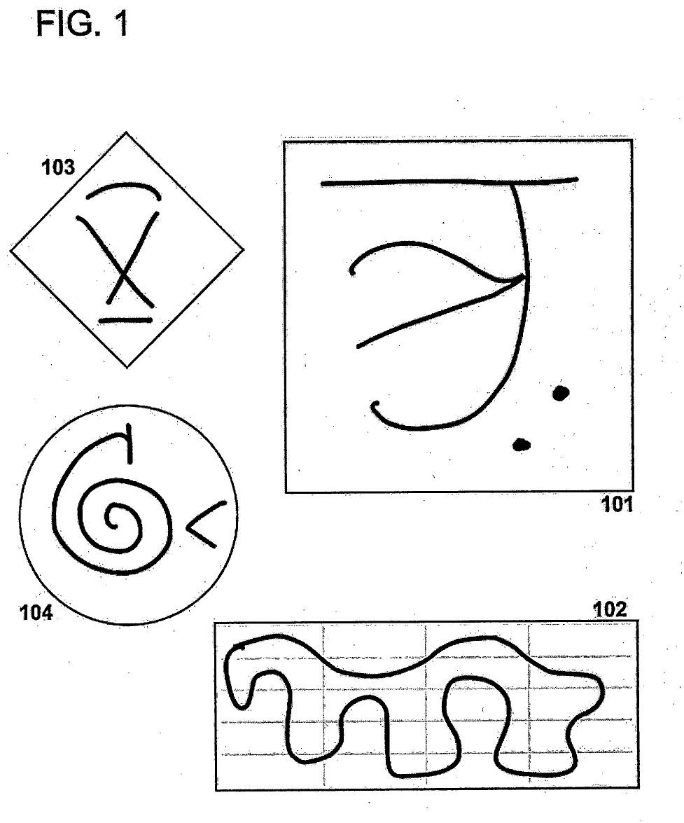

FIG. 1 shows several examples of user input areas with example marks. The input area might be a square area (101), a rectangular area (102), a rotated area of any shape (103), a circle (104) or another input area shape. The input area might have grid lines (102) or another form of user guide, or might be blank (101, 103, 104). In the example implementation, we use a 300×300 pixel area with a blank background and offer the user 10 seconds to draw the mark.

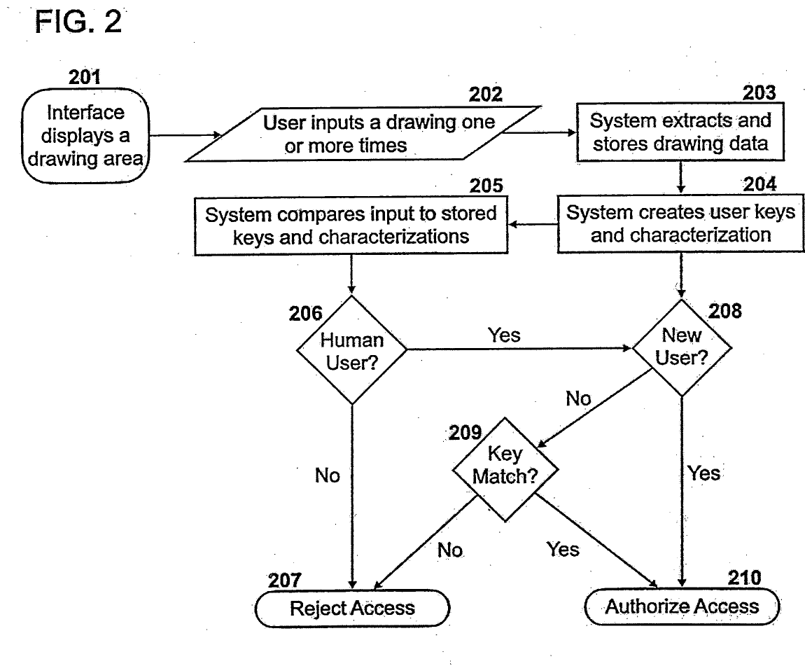

FIG. 2 shows a flow chart with an example implementation of the method. The user inputs the symbol or mark, consisting of one or more points and/or lines, a total of five times to establish a new mark that will be associated with that user's account, when a new user is registering with the system (202). Multiple drawings of the same mark by that user offers the system an opportunity to characterize the mark as drawn by that specific user to set a baseline for later comparison. When the user returns to the system for subsequent visits, the user is asked to draw the mark only once.

The example system implementing this method then extracts and stores data associated with the mark as the user has drawn it (203). The data extracted includes the precise coordinates contained in the mark, timestamps on each coordinate, and measures of the historical variations in coordinates and timestamps found in each repetition of the mark on the first and subsequent visits. The cadence of the mark (the timing, natural or planned pauses and stops) as recorded in the timestamps on each coordinate and in the time differences between various points in the mark are also stored. The stored data structure further includes measures of the patterns or curves in the drawing, relationships between one or more points or parts of the drawing, acceptable translations and transformations for the drawing, and measures of the natural variations in timing and placement in the drawings between the first time the user entered it and subsequent repetitions of the drawing.

The stored data is then used to create user keys and to characterize the mark and the user who drew the mark (204). These keys and characterizations are then compared against the current claimed user and other users in the system.

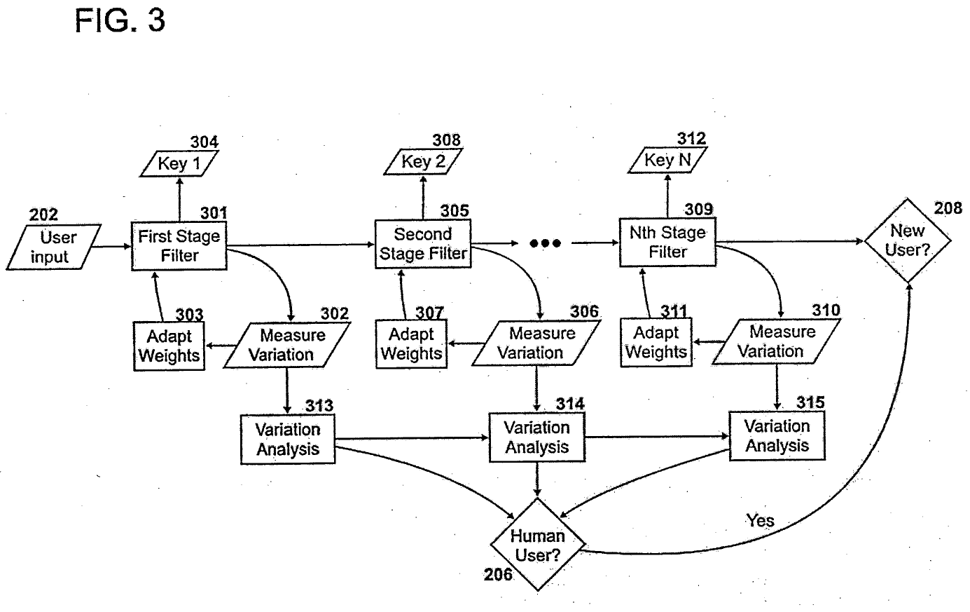

This process is seen in more detail in FIG. 3. In the example implementation, the process of producing keys and characterizations for the user input consists of several filters. Each filter (301, 305, 309) uses a Linear Adaptive Adder algorithm to determine if the user has entered the correct mark. The first filter (301) is a high level filter asking if the user began drawing the mark in the correct quadrant of the drawing area. A second filter (305) is more granular, measuring the total length of time taken for the drawing, number of stops and number of distinct dots or lines in the drawing. Subsequent filters (309) contain yet more detailed filtering criteria and measures including the complete set of precise coordinate points of the mark, the timing of the points, difference in time between the points, and curves found within the mark.

Each filter in the example implementation produces keys based on this user's drawing of the mark (304, 308, 312). Both the raw data and the produced keys serve as criteria to deny the user entry to the system. Filter 301 produces a simple quadrant key (304) that looks like q1, q2, q3 or q4. Filter 305 produces another simple key (308) that looks like t-p-d-l based on the total time taken to draw the mark (t), the number of pauses or stops (p), the number of dots (d) and the number of lines (I). Later filters (309) produce the desired quantum safe keys (312) based on the timestamped precise coordinates within the user's mark as seen below.

In the example implementation, the filter (309) that checks the validity of the set of 300 coordinate points with timestamps on each point, uses those points as (x, y, t), where t is the timestamp, to create the seed for a quantum-safe encryption key, and then to create the key. In this example, the system considers all of the 100 timestamped points in the mark as a concatenated string. A set of points
{(x1, y1, t1), (x1, y2, t2), (x3, y3, t3), . . . (x100, y100, t100)} is used to make a quantum-safe encryption seed through concatenation as
x1y1t1x2y2t2×3y3t3 . . . x100y100t100.

Introducing additional information and measures on the placement and cadence of the mark in the example implementation, the seed becomes even more complex.

Information about the quadrants or subregions that the mark touches on within the drawing area are characterized as:
x1y1t1Q1 x2y2t2Q2×3y3t3Q3 . . . x100y100t100Q100.

Measures of intentional or natural pauses and stops while drawing the mark are included in the seed by showing how many microseconds pause (p) exist between points or lines, yielding a final seed of the form:
x1y1t1Q1 p1 x2y2t2Q2 p2×3y3t3Q3 . . . p99 x100y100t100Q100.

Measures and information about the mark can be combined in any number of ways for an even more complex seed, depending on the security needs of the system. This seed is then used within a quantum-safe encryption algorithm to create public and private quantum-safe keys. In the example implementation, we use the Advanced Encryption Standard (AES) quantum-safe encryption algorithm.

For each filter, variations in the data associated with that particular filter are measured (302, 306, 310) and compared, by the Linear Adaptive Adder algorithm, to previous iterations of the mark by this user. The results are used to adjust weights (303, 307, 3011) thereby training the individual filters to recognize this specific user.

Variations in the user's drawing data, and in the measures carried out on the data, are analyzed (313, 314, 315) via a Convolutional Neural Network to determine if the user is human (206), and to determine if the user is the unique human they claim to be. The invention uses the natural variations in the user's repetitions of the drawing on each visit, to recognize the individual human who drew it. Instead of throwing out the variations in each repetition, and seeking a graphical password drawing that is “close enough” for authentication, the method uses the natural human variations as a non-biometric fingerprint for the user. In the example implementation, this is accomplished using a Convolutional Neural Network trained on the user's initial set of five repetitions of the mark when they first registered. This same neural network, also trained on all users' marks, learns to recognize a human making a mark (in general), and to recognize the same human repeating their own mark.

The feature extraction and variation analysis in the example implementation (313, 314, 315) includes Convolutional Neural Networks (CNN), which are widely applied to pattern-recognition and image-recognition problems today. The numeric weights of the CNN in the example implementation are tuned using training data generated on each user input, first from a large bank of human volunteers, and then from actual system users. The CNN network in the example implementation consists of multiple layers of feature-detection “neurons”. Each layer has many neurons that respond to different combinations of inputs from the previous layers. The layers are built so that the first layer detects a set of primitive patterns in the input, the second layer detects patterns in the patterns and so on. The example implementation has CNNs with 5 layers with a possibility of adding up to 25 layers to improve performance. Training uses general-purpose methods to iteratively determine the weights for intermediate and final feature neurons. The example implementation includes a pre-processing stage (noise reduction and image scaling), a CNN Region of Interest (ROI) selector (object detection and feature extraction), CNN precise ROI modeling (feature matching and gesture recognition, where the user's drawing data is used to define a gesture) and a decision making neural network classifier (human characteristic matching).

For human beings, there is a natural variation in each repetition of the mark. That is, the same person will draw their personal mark slightly differently each time. The organic nature of the human body and nervous system, changing eyesight over time, changing moods, health and sleep patterns, all contribute to offer a different kind of variation in each repetition of the mark than a bot or AI entity can be programmed to deliver. This unique user fingerprint is measured and stored (203) by the system implementing this method.

In the example implementation, variation analysis (313, 314, 315) on the user's current and previous inputs of their personal mark includes additional application of: Fourier Transforms, Time-Domain Analysis, Frequency Analysis, and Statistical Analysis to augment the insights from the CNN.

Current bots and AI entities used today can produce an image in whole as a file, but cannot yet draw on an area in a user interface. A bot or AI entity could be programmed in the future, first, to draw a mark precisely, and then, to vary how they draw a given mark, but those programmed variations will show a level of predictability or a telltale pattern in the variations inconsistent with that of a human being. Bots and AI entities could be able to create a mark in the future but will, for example, make the mark too precisely each time, or with non-human patterns in the programmed variations such as stochastic noise in the variations, or even variations that are too random to be human.

The example implementation (313, 314, 315) includes further analysis, within the CNN as detailed above, of the changes in variations in the timestamped coordinates over time for each user. For example, a user has natural variations each time they draw their personal mark, and on top of that, there will be variations in their variations, over time. This meta-variation analysis trains the system on the natural long term physiological and neurological changes in the user over time.

If the system determines that the user is human (206), the system then determines if the user is a new user (208) (as opposed to a previous user attempting to make a new alternate account, or an unknown or known user attempting to gain access to another person's account). Another human being, even one who knew what the mark looked like, and who knew the order in which to draw it, would involuntarily demonstrate different variations in the placement and cadence of the mark's elements, thereby giving themselves away as an unauthorized user.

If the system determines that the user is not human (206), access to the system is rejected (207). If the system in the example implementation determines that this is a human user (206), and that the user is a new user (208), then the system authorizes access to a new account for this user (210). If the user is not new, the system checks to see if the keys produced by the user input (204) are a match to the user they are claiming to be (209). If the keys match, access is granted to the user for that account (210). If the keys do not match, user access is rejected (207). At this point, the example implementation has required both proof that the user is human and that the user is the unique human who owns that particular account.

Other example implementations of the invention may use the method only to prove unique personhood, or only for bot detection.

1. A method for proof of unique personhood of a user in a computer-based system comprising: user designation and drawing of a mark consisting of one or more points and/or lines that serves as proof of the user's unique personhood; associated measures pertaining to the mark including any of: the precise coordinate points of the drawings, timestamps or other timing or cadence related information for each point or set of points or lines drawn, information on or measures of the patterns or curves in the drawing, relationships between one or more points or parts of the drawing, acceptable translations or transformations for the drawing, and/or measures or representations of the intended and natural variations in timing and placement in the drawings between the first time the user entered it and subsequent repetitions of the drawing, and representation of the user's unique patterns and measures as would distinguish this user from another user drawing the same mark.

2. The method as recited in claim 1, wherein the user designs or creates their own mark, or wherein the user chooses a mark from a set of one or more predetermined marks or randomly created marks offered to them by the system implementing the method.

3. The method as recited in claim 1, wherein the system implementing the method trains an adaptive algorithm, other machine learning algorithm, or artificial intelligence to recognize the user based on the data from the user's first N drawings of the mark.

4. The method as recited in claim 1, wherein the system implementing the method trains an adaptive algorithm, other machine learning algorithm, or artificial intelligence instance to recognize the user based on the data from every visit of the user where the user draws their mark.

5. The method as recited in claim 1, wherein the system implementing the method trains an adaptive algorithm, other machine learning algorithm, or artificial intelligence instance to recognize the user based on measures of how the user's drawing data and variations in drawing measures change and evolve over time.

6. The method as recited in claim 1, wherein the system implementing the method trains an adaptive algorithm, other machine learning algorithm, or artificial intelligence instance to predict future expectations of how the user will evolve in the data and measures of variation of how they draw the mark over time.

7. The method as recited in claim 1, wherein the system implementing the method trains an adaptive algorithm, other machine learning algorithm, or artificial intelligence instance to determine demographic or other information about the user.

8. The method as recited in claim 1, wherein the measures across one or more human users and one or more bots or AI entities are used to train the system to recognize human users versus bots or artificial intelligence entities or other non-human users.

9. The method as recited in claim 1, wherein the measures of the marks of one user are used to train the system using an adaptive algorithm, other machine learning algorithm, or artificial intelligence instance to recognize that particular user across multiple accounts.

10. The method as recited in claim 1, wherein the mark and/or its associated data or measures are used as a form of user authentication or passcode.

11. The method as recited in claim 1, wherein the mark and/or its associated data and measures are used to produce encryption seeds of sufficient length and complexity as to be quantum-safe.

12. The method as recited in claim 1, wherein the input drawing area of the user interface includes a blank area, grid, image or other forms of background guides for the user to draw the mark on top of or within.

13. The method as recited in claim 1, wherein the input drawing area may be rotated by the user or by the system prior to or as the user draws, or wherein the input drawing area may be of different shapes and sizes.

14. The method as recited in claim 1, wherein the method is implemented in software including but not limited to in a user interface for a website or other system, in a software plugin for use in another system or set of systems, in a database, in machine learning algorithms, in artificial intelligence (AI) algorithms or systems, in AI training software and/or in other computer code.

15. The method as recited in claim 1, wherein the method is implemented in a centralized or decentralized computer system.

16. The method as recited in claim 1, wherein the method is implemented in hardware on a single physical device or set of physical devices.

17. The method as recited in claim 1, wherein the method is implemented in a combination of software and hardware components.

18. The method as recited in claim 1, wherein the method is implemented in a stand alone system or integrated with another system.
